(19) United States
(12) Patent Application Publication
(10) Pub. No.: US 2015/0161295 A1
(43) Pub. Date: Jun. 11, 2015

(54) CAE ANALYSIS METHOD AND CAE ANALYSIS APPARATUS

(71) Applicant: TOYOTA JIDOSHA KABUSHIKI KAISHA, Toyota-shi (JP)

(72) Inventors: Kosuke Arita, Toyota-shi (JP); Mai Suzuki, Kariya-shi (JP); Keiji Shinohara, Nagoya-shi (JP)

(21) Appl. No.: 14/514,921

(22) Filed: Oct. 15, 2014

(30) Foreign Application Priority Data
Dec. 5, 2013 (JP) 2013-252163

(51) Int. Cl. G06F 17/50

(52) U.S. Cl. CPC G06F 17/50

(57) ABSTRACT

A CAE analysis method is provided in which a computer is caused to perform modeling in which: a model formed by solid elements is applied for each of the plurality of members, based on given data representing a region to be analyzed of the plurality of members;
a model formed by a shell element is applied for each weld joint formed between two members of the plurality of members, based on given data representing a region to be analyzed of the weld joints; and the shell element applied as the model for each weld joint is arranged inside a dihedral between welded surfaces of the two members, and is coupled to the solid elements applied as the model for each of the two members through internode connection such that each solid elements applied for the two members is coupled via rigid elements or beam elements to the shell element respectively.

### BACKGROUND

1. Field

The present invention relates to a CAE (Computer Aided Engineering) analysis technique that causes a computer to perform modeling of an object to be analyzed, and analyze behavior of a model generated by the modeling.

2. Description of the Related Art

CAE analysis performed by a computer is widespread. In the CAE analysis, a computer converts a target object into CAD (Computer Aided Design) data, and performs modeling of the target object having been converted into the CAD data, to analyze strength of a structure, stress distribution, a material deformation characteristic, and the like by using an analysis method such as a finite element method. Also for vehicles, the CAE analysis is developed, and various calculations for engine structures, body structures, and the like are performed.

Japanese Laid-Open Patent Publication No. 2012-112852 discloses that, in a structure where sheet metals are welded to each other, a weld joint is modeled by a shell element which is a finite element for the CAE analysis.

### SUMMARY

For a welded object in which sheet metals are welded by arc welding, in the case of modeling of an arc-weld joint being performed for the CAE analysis, each sheet metal is modeled conventionally by using solid elements which are finite elements. For one of the sheet metals, shell elements are arranged on surfaces of the solid elements adjacent to the arc-weld joint, and the shell elements are coupled, under a contact definition, to nodes of the solid elements, of the other of the sheet metals, adjacent to the arc-weld joint.

However, such arrangement of the shell elements increases the number of model generating steps. Further, the nodes of the solid elements are set so as to merely transfer displacement (only three translational degrees-of-freedom in the respective directions of xyz-axes is allowed). Therefore, moment transfer between the sheet metals cannot be represented by the above modeling. In a case where moment transfer cannot be represented, an analysis result may include a local deformation at the coupling portions between elements, and may not represent an actual phenomenon.

Modeling of the entirety of a bead of arc welding by very small solid elements instead of the shell elements is also attempted so as to emulate behavior approximate to actual behavior of an arc-weld joint. However, in this case, shapes of the solid elements of the bead of the arc welding are formed depending on a mesh form formed by the solid elements of the sheet metal portions, so that too many steps of model generating are required and modeling of the bead of the arc welding needs to be performed by using extremely small solid elements with a micro mesh pitch.

The present invention is made in view of the above problems of the conventional art, and an object of the present invention is to make available a CAE analysis method and CAE analysis apparatus that can perform an appropriate modeling for a weld joint between a plurality of members in a simple manner, with a capability of representing moment transfer.

In order to overcome the aforementioned problems, a first invention is directed to a CAE analysis method that causes a computer to perform modeling of an object including a plurality of members welded to each other and weld joints formed among the plurality of members, and perform a CAE analysis. In the CAE analysis method, the computer is caused to perform the modeling in which: a model formed by solid elements is applied for each of the plurality of members, based on given data representing a region to be analyzed of the plurality of members, a model formed by a shell element is applied for each weld joint formed between two members of the plurality of members, based on given data representing a region to be analyzed of the weld joints, and the shell element applied as the model for each weld joint is arranged inside a dihedral between welded surfaces of the two members, and is coupled to the solid elements applied as the model for each of the two members through internode connection such that the solid elements applied for one of the two members is coupled via rigid elements or beam elements to the shell element and the solid elements applied for the other of the two members is coupled via rigid elements or beam elements to the shell element.

Further, according to a second invention based on the first invention, the shell element that is applied as the model for each weld joint is arranged on a given surface figure that bridges the welded surfaces of the two members through the dihedral.

Further, in order to overcome the aforementioned problems, a third invention is directed to a CAE analysis apparatus that performs, by a computer, modeling of an object including a plurality of members welded to each other and weld joints formed among the plurality of members, and performs a CAE analysis. In the CAE analysis apparatus, the computer performs the modeling in which: a model formed by solid elements are applied for each of the plurality of members, based on given data representing a region to be analyzed of the plurality of members, a model formed by a shell element is applied for each weld joint formed between two members of the plurality of members, based on given data representing a region to be analyzed of the weld joints, and the shell element applied as the model for each weld joint is arranged inside a dihedral between welded surfaces of the two members, and is coupled to the solid elements applied as the model for each of the two members through internode connection such that the solid elements applied for one of the two members is coupled via rigid elements or beam elements to the shell element and the solid elements applied for the other of the two members is coupled via rigid elements or beam elements to the shell element.

Further, according to a fourth invention based on the third invention, the shell element that is applied as the model for each weld joint is arranged on a given surface figure that bridges the welded surfaces of the two members through the dihedral.

According to the first invention, each node of the shell element applied for the weld joint is allowed to have a rotational degree-of-freedom. Therefore, moment transfer via the weld joint can be appropriately represented. Further, a shape of the shell element applied as the model for the weld joint can be determined regardless of a mesh form formed by the solid elements applied for the members, whereby moment transfer can be represented with a simple structure. Thus, the CAE analysis method can be provided in which an appropriate modeling can be performed for a weld joint between a plurality of members in a simple manner, with representation of moment transfer enabled by the modeling.

According to the second invention, input to the welded portion and transmission of the input can be easily emulated so as to be approximated to an actual behavior.

According to the third invention, the CAE analysis apparatus can be provided in which an appropriate modeling can be performed for a weld joint between a plurality of members in a simple manner, with representation of moment transfer enabled by the modeling.

According to the fourth invention, input to the welded portion and transmission of the input can be easily emulated so as to be approximated to an actual behavior.

### BRIEF DESCRIPTION OF THE DRAWINGS

FIG. 1 illustrates models that are applied for an object according to an embodiment of the present invention;

FIG. 2 is a block diagram illustrating a hardware configuration used for a CAE analysis apparatus according to the embodiment of the present invention;

FIG. 3 is a block diagram illustrating a function of the CAE analysis apparatus according to the embodiment of the present invention;

FIG. 4 is a flow chart showing a CAE analysis method according to the embodiment of the present invention;

FIG. 5 illustrates one aspect of a process of the CAE analysis method according to the embodiment of the present invention;

FIG. 6 illustrates another aspect of the process of the CAE analysis method according to the embodiment of the present invention;

FIG. 7 illustrates an example of a process for arranging a shell element in the CAE analysis method according to the embodiment of the present invention;

FIG. 8 illustrates another example of the process for arranging a shell element in the CAE analysis method according to the embodiment of the present invention;

FIG. 9 illustrates still another example of the process for arranging a shell element in the CAE analysis method according to the embodiment of the present invention;

FIG. 10 illustrates models that are applied as comparative example for the embodiment of the present invention;

FIG. 11 illustrates other models that are applied as comparative example for the embodiment of the present invention; and

FIG. 12 illustrates still other models that are applied as comparative example for the embodiment of the present invention.

### DETAILED DESCRIPTION

An embodiment of the present invention will be described below with reference to the drawings.

<Model Used for CAE Analysis>

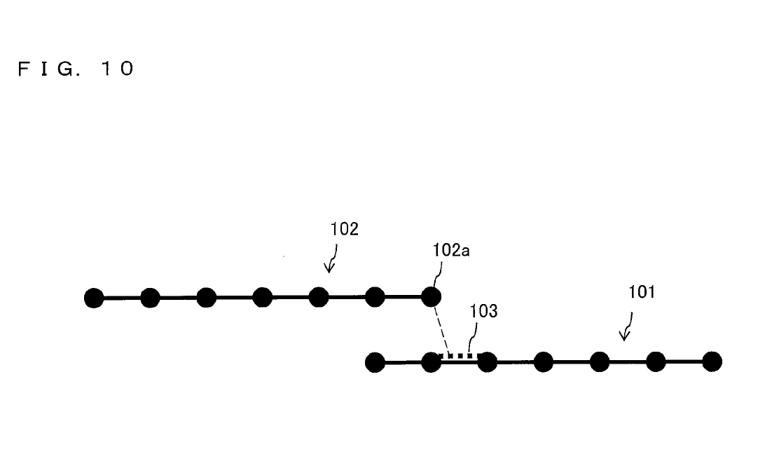

Firstly, a CAE analysis for a weld joint between sheet metals will be described with reference to FIGS. 10 to 12. For the CAE analysis described with reference FIGS. 10 to 12, a modeling technique in which solid elements and shell elements are used, and a modeling technique in which only solid elements are used, will be described.

FIG. 10 illustrates coupling under a contact definition in the case of modeling of sheet metal portions at the thickness center by shell elements. A shell element 103 that is a part of a shell element 101 representing an object (one of sheet metals), and a node 102a of a shell element 102 representing another object (the other of the sheet metals) are coupled to each other under the contact definition. It is assumed that the profiles of the shell elements 101 and 102 in FIG. 10 are repeated over a predetermined range in a direction perpendicular of the cross-section. The shell element 103 is an element of surface figure (a surface figure of the shell element 101), and a cross-sectional structure of the shell element 103 shown in FIG. 10 is continuously formed over a predetermined range in the direction perpendicular to the cross-section.

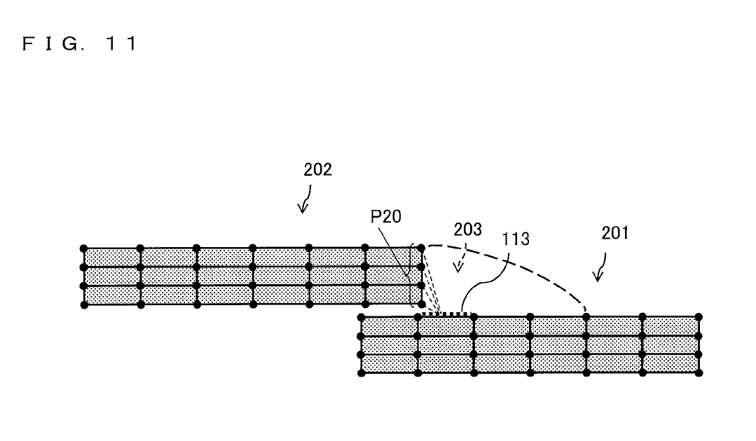

FIG. 11 illustrates an exemplary case where coupling under a contact definition as described above is applied to represent a weld joint (which is, but not limited to, an arc-weld joint) between two sheet metals in the case of modeling of the sheet metal portions by solid elements instead of shell elements. A portion indicated in FIG. 11 represents a cross-section of an object obtained by two sheet metals being welded to each other, and the cross-section is obtained by the object being cut in the direction perpendicular to the bead length direction. One sheet metal 201 and the other sheet metal 202 are welded to each other, by fillet weld, at a weld joint 203 formed in a region within a long dashed line. Solid elements are applied as models for the sheet metal 201 and the sheet metal 202. A plurality of nodes P20 of the solid elements in a surface, of the sheet metal 202, which contacts with the weld joint 203 are coupled, under the contact definition, to the shell element 113 arranged on a surface of the sheet metal 201 (hereinafter, a range of a surface, of any of the sheet metals, which contacts with the weld joint 203, is referred to as a “welded range”). The shell element 113 is arranged to extend over the bead length of the weld joint in the direction perpendicular to the cross-section shown in FIG. 11.

In the modeling shown in FIG. 11, the sheet metal 201 and the sheet metal 202 are merely coupled to each other under the contact definition. Therefore, for example, when analyzing transfer of a stress applied to the sheet metal 202, via the weld joint of the region 203, to the sheet metal 201, moment transfer from the plurality of nodes of the sheet metal 202 to the weld joint 203 cannot be represented. This is because, in the modeling of a solid such as the sheet metals, the nodes are allowed to have only three translational degrees-of-freedom in the respective directions of xyz axes of the orthogonal space axes. Therefore, an action from the weld joint 203 to the sheet metal 201 according to the moment cannot be represented, either. In this case, behavior of the object including the sheet metals 201 and 202 and the weld joint 203 as is obtained by the analysis, may deviate from actual behavior.

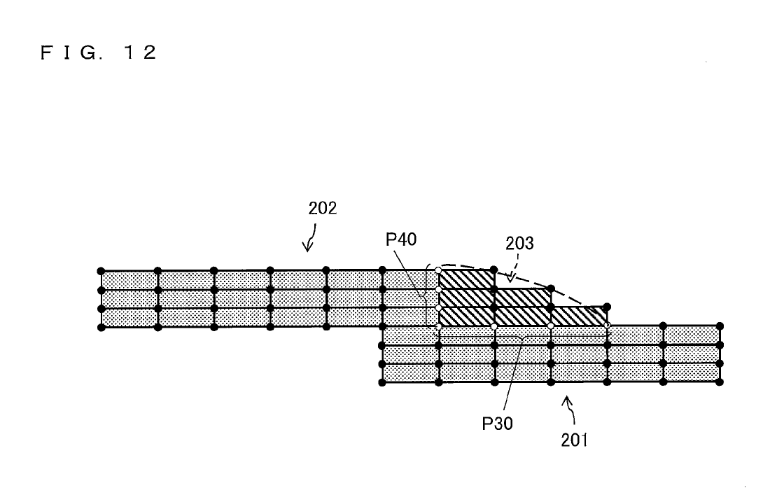

FIG. 12 illustrates an exemplary case where the weld joint 203 is modeled by solid elements without arranging a shell element on the sheet metal 201, and illustrates a cross-section as viewed in the same direction as in FIG. 11. A cross-sectional structure of the weld joint 203 shown in FIG. 12 is continuously formed also in the direction perpendicular to the cross-section, and forms a bead over the entirety thereof In this case, the entirety of the bead is modeled with the use of a great number of solid elements, and the solid elements have shapes and sizes that depend on a mesh form formed by the solid elements of the sheet metals 201 and 202. In FIG. 12, the solid elements of the weld joint 203, and the solid elements of the sheet metals 201 and 202 are defined to share a plurality of nodes P30 located at the boundary between the sheet metal 201 and the weld joint 203 as indicated by outlined circles, and a plurality of nodes P40 located at the boundary between the sheet metal 202 and the weld joint 203 as indicated by outlined circles. Therefore, the shapes of the solid elements of the weld joint 203 depend on a mesh form formed by the solid elements of the sheet metals 201 and 202. If behavior of the object composed of the sheet metals 201 and 202 and the weld joint 203 as is obtained by the analysis is attempted to be approximated to actual behavior by using this modeling, the solid elements need to be formed into fine meshes, so that a great amount of model generating time is spent.

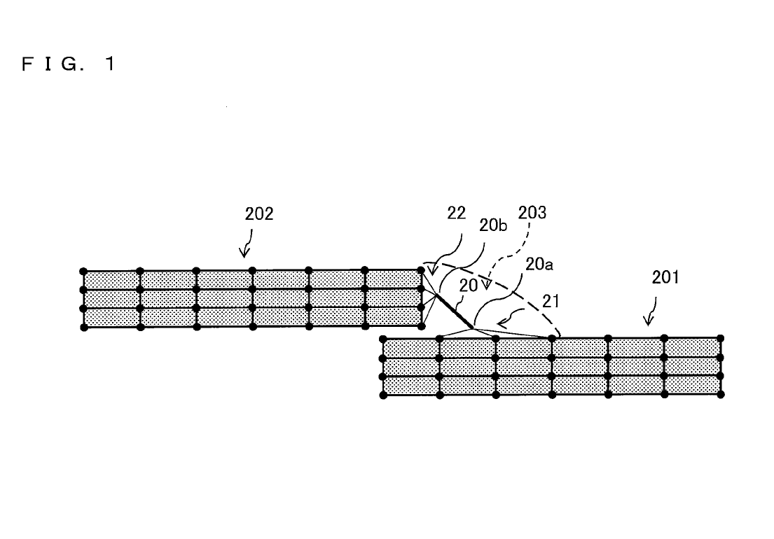

Thus, in the present embodiment, as shown in FIG. 1, a shell element 20 is applied as a model for the weld joint 203. In the description herein, the shell element 20 is formed so as to be, for example, a plane figure. However, the shell element 20 may be a curved surface figure. Further, the shell element 20 may be divided into a plurality of elements. The shell element 20 is coupled to the sheet metal 201 to which solid elements are applied, via coupling elements 21 formed as a plurality of rigid elements or beam elements, and the shell element 20 is coupled to the sheet metal 202 to which solid elements are applied, via coupling elements 22 formed as a plurality of rigid elements or beam elements. FIG. 1 is a cross-sectional view of an object to be subjected to the CAE analysis as viewed in the same direction as in FIG. 11 and FIG. 12. The rigid elements are not individually deformable whereas the beam elements are individually deformable. The coupling elements 21 and the coupling elements 22 may be formed as the same elements or as elements different from each other.

The shell element 20 is arranged to extend over the bead length. The shell element 20 has a side edge 20a opposing the sheet metal 201 and a side edge 20b opposing the sheet metal 202. The side edge 20a and the side edge 20b are opposite sides.

On the cross-section shown in FIG. 1, exemplified is a case in which the side edge 20a is coupled to a plurality of nodes of the solid elements in the welded range of the sheet metal 201, and the side edge 20b is coupled to a plurality of nodes of the solid elements in the welded range of the sheet metal 202. The number of nodes, in each welded range, coupled to the side edges 20a and 20b respectively may be greater than or equal to one in general. Each of the side edges 20a and 20b may be coupled to all the nodes in the respective welded ranges, or may be coupled to a portion of the nodes in the respective welded ranges.

Further, a plurality of nodes are arranged on each of the side edges 20a and 20b to be aligned in the bead length direction. The plurality of nodes of the sheet metal 201 aligned in the bead length direction are coupled to the nodes of the side edge 20a, each coupling being involved in any combination relationship such as one-to-one, many-to-one, and one-to-many. The plurality of nodes of the sheet metal 202 aligned in the bead length direction are coupled to the nodes of the side edge 20b, each coupling being involved in any combination relationship such as one-to-one, many-to-one, and one-to-many. Each coupling element 21 may be arranged parallel to the cross-section or may be arranged to include an individual component of the bead length direction. Further, on the surface of the shell element 20, two axes orthogonal to each other are defined, and each node of the side edge 20b has a rotational degree-of-freedom around either of the axes. For example, an axis parallel to the side edges 20a and 20b is defined as a first axis (that is, an axis that extends in the bead length direction), and an axis orthogonal to the first axis is defined as a second axis. The first axis and the second axis need not include a parallel axis to the bead length direction. The shell element 20 may be a plane surface figure or may be a curved surface figure, and common orthogonal axes may not be always defined over the entirety of the surface of the shell element 20. In the present embodiment, it is satisfactory if orthogonal axes are defined at any target nodes of the side edges 20a and 20b with the rotational degrees-of-freedom set around them. Alternatively, a rotational degree-of-freedom around a normal axis to the surface of the shell element 20 may be added to those around the two orthogonal axes so that total three rotational degrees-of-freedom around the respective axes are allowed. In the above example, the nodes of the side edge 20a and the nodes of the side edge 20b are targets to be coupled to the sheet metals 201 and 202. However, the present invention is not limited thereto. Nodes located at any positions on the shell element 20 may be selected as the targets. Namely, the solid elements of the sheet metals 201 and 202 may be coupled via the coupling elements 21 and 22 to the shell element 20 through internode connection.

Further, in the present embodiment, none of the nodes of the side edge 20a .is allowed to have a rotational degree-of-freedom, but may be allowed to have the degree-of-freedom as is regarding each node of the side edge 20b. Alternatively, the nodes of the side edge 20a may have the same rotational degree-of-freedom or the same rotational degrees-of-freedom among themselves, and the nodes of the side edge 20b may have the same rotational degree-of-freedom or the same rotational degrees-of-freedom among themselves. Such a definition of a rotational degree-of-freedom or a shape of the shell element 20, varies depending on, for example, a purpose of calculation, that is, from which direction and to which portion of an object stress is applied, and which portion of the object the applied stress affects.

In a case where, as shown in FIG. 1, the shell element 20 is coupled to the solid elements of the sheet metals 201 and 202 via the coupling elements 21 and 22, moment transfer can be appropriately represented as described below. It is assumed that the sheet metal 202 buckles under stress with its end surface on the weld joint side deflected from the vertical of FIG. 1, as an exemplary case. The coupling elements 22 can rotate around the nodes of the shell element 20 on the side edge 20b, whereas the coupling elements 22 cannot rotate around the nodes of the solid elements of the sheet metal 202. Therefore, the deflection of the end surface is accompanied by transfer of such moments as they rotate the entirety of the coupling elements 22 around the nodes of the side edge 20b. In a case where none of the nodes of the side edge 20a is not allowed to have a rotational degree-of-freedom, it is possible to simulate a situation where an input from the sheet metal 202 to the shell element 20 is transferred to the whole region of the shell element 20 and the sheet metal 201. In the course thereof, when the rigid members are used for the coupling elements 21 or the coupling elements 22, behavior under a condition where the sizes and shapes of the rigid elements are fixed is calculated, whereas, when the beam elements are used for the coupling elements 21 or the coupling elements 22, behavior under a condition where possible changes in the sizes and shapes of the beam elements depending on a given characteristics and extrinsic conditions are into consideration, is calculated. Thus, in the modeling that appropriately distributes rotational degrees-of-freedom to the nodes coupled to the coupling elements by using the shell element 20 as a model, behavior in the weld joint caused by the moments can be emulated under the constraint conditions for deflection of the welded surfaces of the sheet metals 201 and 202.

Further, the modeling using the above-described model for the weld joint 203 in order to produce couplings with the coupling elements 21 and 22, offers a simple configuration such that the weld joint 203 can represent moment transfer without depending on the shapes of the solid elements of the sheet metals 201 and 202. Therefore, the modeling and subsequent analysis does not need exhaustive calculation and processing time.

### <Configuration of Apparatus for Performing CAE Analysis>

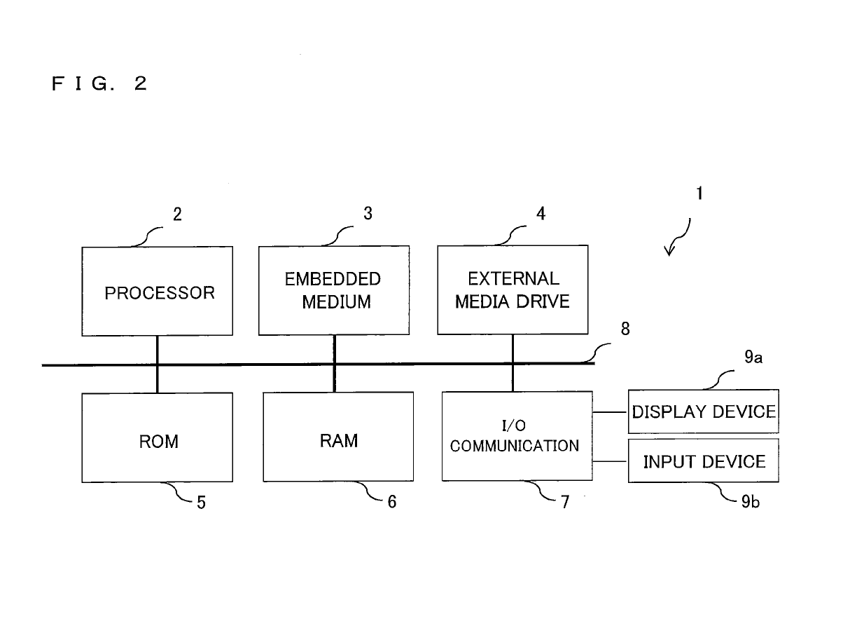

Next, FIG. 2 illustrates a configuration of hardware 1 of an apparatus (hereinafter, referred to as a “CAE analysis apparatus”) for performing the CAE analysis according to the present embodiment. The hardware 1 has a computer device configuration that includes a processor 2, an embedded medium 3, an external media drive 4, a ROM 5, a RAM 6, an interface device 7, and a bus 8 that connects these components to each other. Examples of the computer configuration include configurations of personal computers and configurations according to workstation architectures.

The processor 2 is implemented as a general-purpose processor or a dedicated processor that executes a program loaded into the RAM 6 from the embedded medium 3, the external media drive 4, or the ROM 5. The embedded medium 3 is a storage medium such as a magnetic disk. The external medium is a storage medium such as an optical disc, a magnetic disk, and a non-volatile memory. The interface device 7 collectively represents an input/output interface (I/O) for an external connection device, a communication interface, and the like. To the interface device 7, for example, a display device 9a, an input device 9b, and a printing device (not shown) for performing an input process for a user and visualizing a process state, are connected as appropriate. Connection with a network such as a LAN and the Internet can be provided through the communication interface.

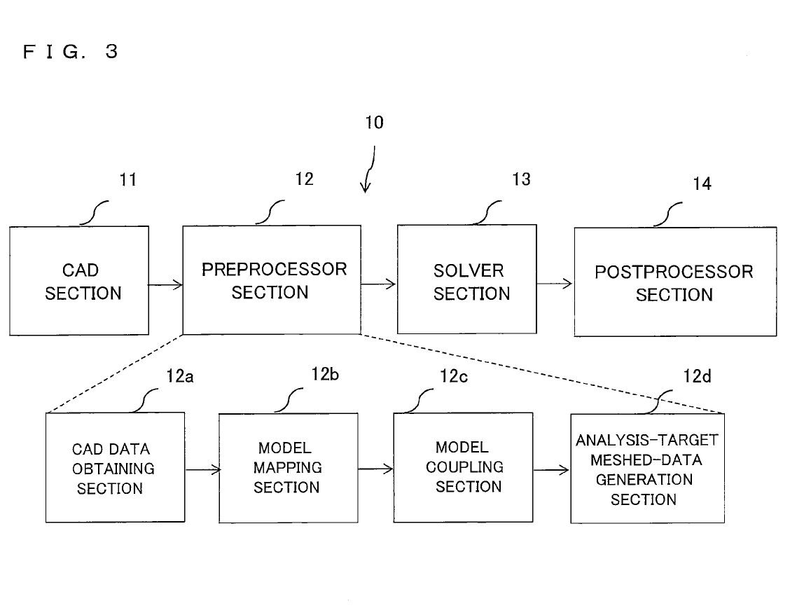

FIG. 3 is a functional block diagram of a CAE analysis apparatus 10 that is implemented by the hardware 1 having the above configuration and a program for executing the CAE analysis being combined with each other. The functional block includes, for example, a CAD section 11, a preprocessor section 12, a solver section 13, and a postprocessor section 14. The CAD section 11 generates figure data representing an object to be subjected to the CAE analysis. The preprocessor section 12 performs modeling of the object based on the given data generated by the CAD section 11. The preprocessor section 12 includes a CAD data obtaining section 12a, a model mapping section 12b, a model coupling section 12c, and an analysis-target meshed-data generation section 12d. The CAD data obtaining section 12a receives data generated by the CAD section 11, and converts the CAD data into data appropriately formatted for the preprocessor section 12. The model mapping section 12b performs, for example, the following processes. That is, the model mapping section 12b performs mapping to the regions of an object designated by a user, with regard to element types such as solid elements, shell elements, rigid elements, and beam elements, the sizes of these elements, the numbers of these elements, and the like, including adding attributes to each element such as a translational degree-of-freedom and a rotational degree-of-freedom. The model coupling section 12c couples the elements mapped by the model mapping section 12b. In particular, in the present embodiment, in order to couple the shell element applied for the weld joint, to the solid elements for the sheet metals 201 and 202 by using the coupling elements 21 and 22, the model coupling section 12c determines relative positions of the elements, and performs a process of coupling the elements according to the attributes defined by the user. The analysis-target meshed-data generation section 12d generates and outputs meshed data so as to be analyzable by the solver section 13, based on the object models which have been determined through the process performed by the model coupling section 12c. The solver section 13 performs numerical analysis of the behavior of objects to be analyzed, in the finite element method, with regard to each of the meshed data outputted by the preprocessor section 12, by applying initial conditions and boundary conditions set by a user. The solver section 13 may have an ability of performing numerical analysis in another method such as finite difference method, finite volume method, and boundary element method. The postprocessor section 14 integrates outputs of analysis results by the solver section 13 into output information for a user, to perform visualization of data, statistical processing, or the like.

The processor 2 shown in FIG. 2 may not be a processor common to all the processes. Each of the CAD section 11, the preprocessor section 12, the solver section 13, and the postprocessor section 14 may use a dedicated processor in order to implement the functional configuration of the CAE analysis apparatus 10. An individual device may be implemented for each functional block, or combination of any number of functions can be regarded as one device. For example, the preprocessor section 12 can be regarded as one device. Alternatively, a functional configuration of combination of the CAD section 11 and the preprocessor section 12 can be regarded as one preprocessor device for the CAE analysis.

### <Procedure of Modeling Process>

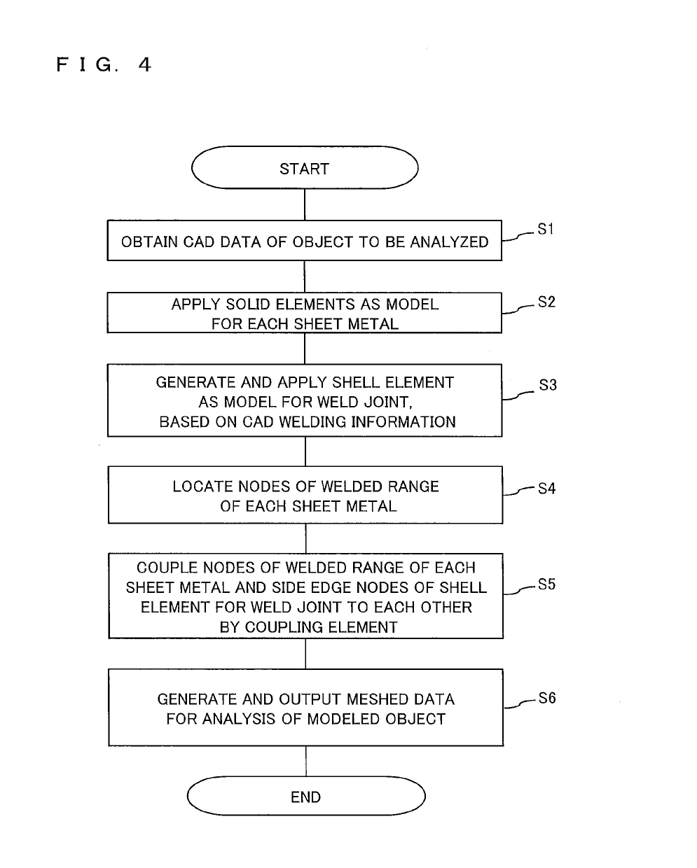

Next, a flow of a process performed by the preprocessor section 12 of the CAE analysis apparatus 10 having the above configuration will be described with reference to FIG. 4 to FIG. 9.

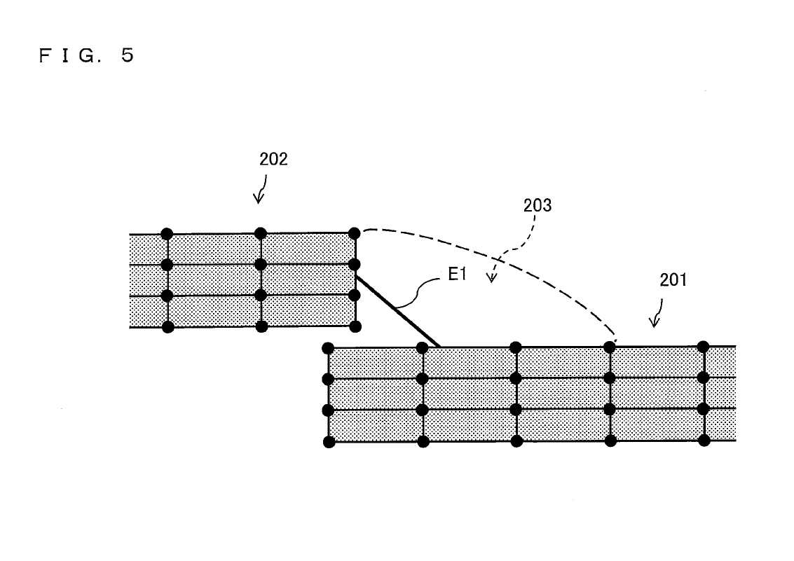

FIG. 4 is a flow chart showing a process performed by the preprocessor section 12. Firstly, in step S1, the CAD data obtaining section 12a of the preprocessor section 12 receives the CAD data from the CAD section 11 and converts the CAD data into data for modeling process. Next, in step S2, the model mapping section 12b performs mapping of solid elements, based on data representing a region, to be analyzed, corresponding to sheet metal portions such as the sheet metals 201 and 202 as shown in FIG. 5, to the region to be analyzed. At this time, the sizes of the solid elements and the number of the nodes are determined according to the user setting.

Subsequently, in step S3, the model mapping section 12b performs mapping of a shell element E1 which the model mapping section 12b has generated and applied as a model for the weld joint 203 in the region to be analyzed as shown in FIG. 5, based on data representing the region, to be analyzed, corresponding to the weld joint 203, and welding information included in the CAD data. The shell element El acts as the shell element 20 that emulates the weld joint as described with reference to FIG. 1. Further, the model mapping section 12b adds information of a translational degree-of-freedom and a rotational degree-of-freedom, as attributes, to the nodes used for coupling according to a rule defined by a user. In the example shown in FIG. 1, information for allowing only three translational degrees-of-freedom is added to the nodes of the side edge 20a. To the nodes of the side edge 20b, information for allowing the three translational degrees-of-freedom, and information for allowing a rotational degree-of-freedom around each of two orthogonal axes defined on the surface of the shell element, or for allowing every rotational degree-of-freedom around three axes which include a normal axis to the surface of the shell element in addition to the two orthogonal axes.

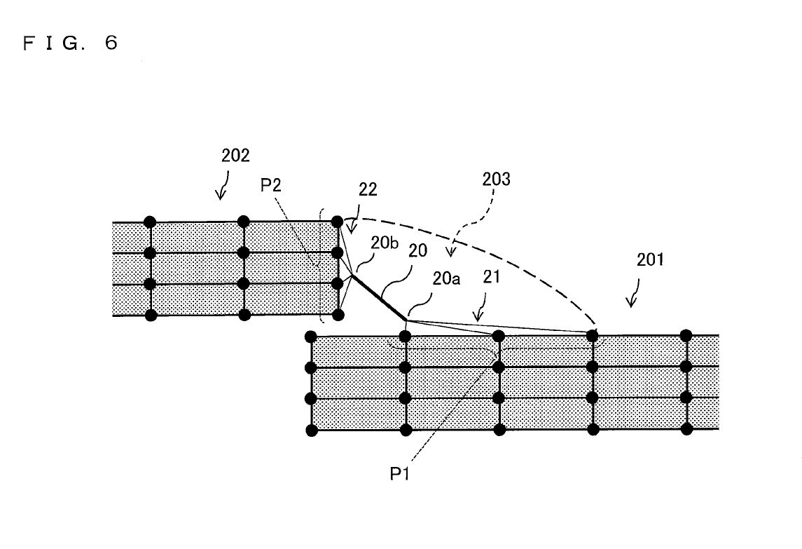

Subsequently, in step S4, the model coupling section 12c locates, in a region to be analyzed of the sheet metal portions, a plurality of nodes P1 distributed to a surface region included in the welded range of the sheet metal 202 and a plurality of nodes P2 distributed to a surface region included in the welded range of the sheet metal 201, as shown in FIG. 6. For example, in a case where there is a sheet metal surface (a surface of the sheet metal 202 in the present embodiment), which contacts with a weld joint having a leg length in the sheet metal thickness direction as is so with the surface including the nodes P1, all the nodes within the welded range of the sheet metal surface having the leg length are located. Further, for example, in a case where there is a sheet metal surface (a surface of the sheet metal 201 in the present embodiment), which contacts with a weld joint having a leg length in a direction different from the sheet metal thickness direction as is so with the surface including the nodes P2, all the nodes within the welded range of the sheet metal surface having the leg length are located.

Subsequently, in step S5, the model coupling section 12c couples the located nodes in the welded ranges of the sheet metal portions and end portion nodes (the nodes on the side edges 20a and 20b) of the shell element of the weld joint via the coupling elements 21 and 22, as shown in FIG. 6. As the nodes used for the coupling, a portion of the nodes among the located nodes as described above may be selected according to a rule defined by a user, instead of all the located nodes.

In step S6, the analysis-target meshed-data generation section 12d generates and outputs meshed data for analyzing the object modeled as described above. Thus, the flow of the present embodiment is ended.

The processor 2 shown in FIG. 2 loads, into the RAM 6, a program stored in the embedded medium 3, an external medium mounted in the external media drive 4, the ROM 5, or the like, and executes the program, thereby performing the modeling process as described above. Further, the processor 2 may download the program from a network through the interface device 7, and execute the program. The program can be supplied as a packaged product in which the program is fixedly stored in a storage medium such as an embedded medium and an external medium.

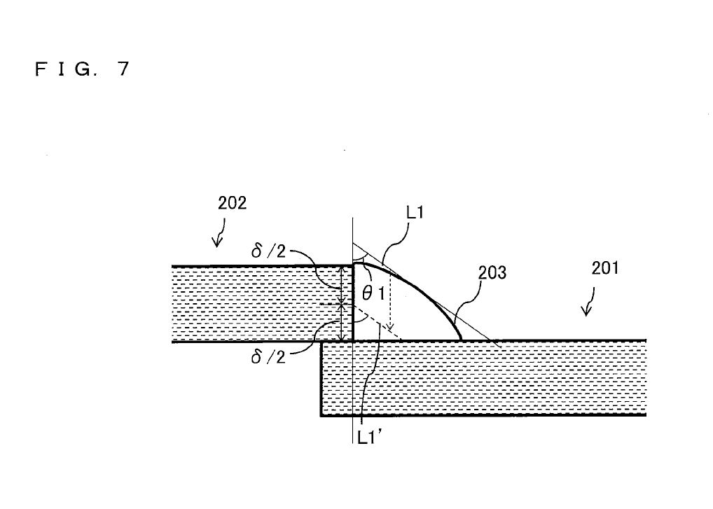

Next, a manner in which a position and an angle at which the shell element El that is applied for the weld joint 203 is arranged are determined, will be described with reference to FIG. 7 to FIG. 9. In FIG. 7 to FIG. 9, for the sake of convenience, the sheet metals 201 and 202 are not represented by solid elements, and only a region to be analyzed is shown for the sheet metals 201 and 202.

As shown in FIG. 1, FIG. 5, and FIG. 6, when analyzing an object with a joint between two sheet metal surfaces orthogonal to each other, the joint being formed by fillet weld inside a dihedral between the two sheet metal surfaces, the shell element applied for the weld joint is arranged inside the dihedral with a predetermined inclination to the two sheet metal surfaces.

In FIG. 7, a cross-section, of the weld joint 203, perpendicular to the bead length direction is regarded as having substantially a right triangular shape. When a tangent line L1 is drawn to the side of the triangular shape corresponding to the bead surface so that the side is approximated to be a straight line by the tangent line L1, an angle θ1 between the tangent line L1 and a reference sheet metal surface (surface of the sheet metal 202 in the present embodiment) having the welded range is set as an angle representing the predetermined inclination. The tangent line L1 is translated so as to pass through the bisection position of a sheet metal thickness δ on the reference sheet metal surface. A line segment L1′ is cut out from the translated tangent line L1 between the two sheet metal surfaces, and the line segment L1′ is defined as a position at which the shell element E1 on the cross-section is arranged. Namely, the line segment that is a cross-sectional profile of the surface of the shell element E1 perpendicular to the bead length direction is on the line segment L1′.

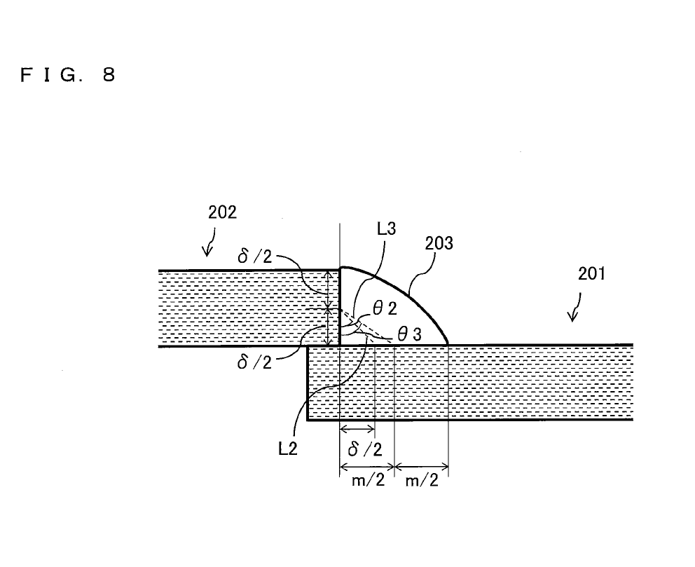

FIG. 8 shows two kinds of methods, that is, a method in which an angle θ2 between a line segment L2 and the reference sheet metal surface is set as an angle representing the predetermined inclination, and a method in which an angle θ3 between a line segment L3 and the reference sheet metal surface is set as an angle representing the predetermined inclination. The line segment L2 is a line segment obtained by connecting between the bisection position of a sheet metal thickness δ on the reference sheet metal surface, and the position distant from the root by the half of the sheet metal thickness δ on the other sheet metal surface, the other sheet metal surface (the surface of the sheet metal 201 in the present embodiment) being orthogonal to the reference sheet metal surface and covering the other weld range. Namely, the angle θ2 is equal to 45 degrees. The line segment L3 is a line segment obtained by connecting between the bisection position of a sheet metal thickness δ on the reference sheet metal surface, and the bisection position of a leg length m of the weld joint 203 on the other sheet metal surface, the other sheet metal surface (the surface of the sheet metal 201 in the present embodiment) being orthogonal to the reference sheet metal surface and covering the other weld range. The line segment L2 and the line segment L3 are used, in their respective methods, as positions at which the shell element E1 on the cross section is arranged.

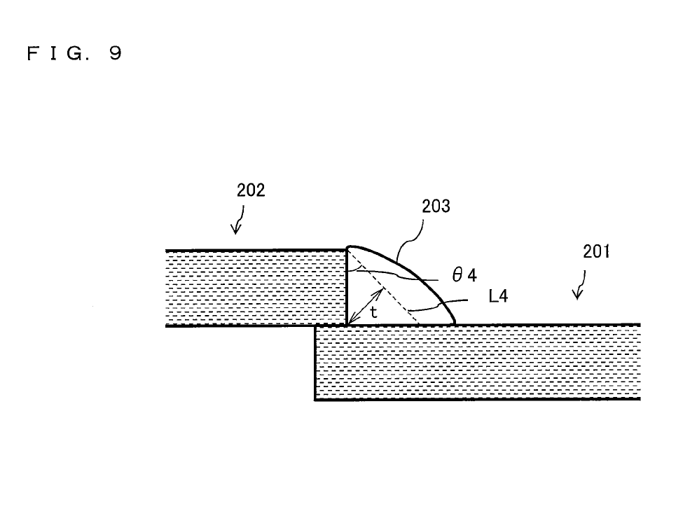

In FIG. 9, an angle representing the predetermined inclination is set as an angle θ4 between the reference sheet metal surface and a line segment L4, the line segment L4 being perpendicular to a segment extending from the root over a distance equal to the throat thickness t. Namely, the line segment L4 corresponds to the 45 degree angled line segment which is drawn from the reference sheet metal surface to the other sheet metal surface when defining the throat thickness t. Thus θ4=45 degrees. The line segment L4 is used as a position at which the shell element E1 on the cross-section is arranged.

The methods of arranging the shell element E1, as described with reference to the respective FIG. 7 to FIG. 9, exemplify that the shell element E1 is arranged on a given surface figure that bridges the welded surfaces of the respective two metal sheets 201 and 202 through the dihedral. Thus, input to the weld joint 203 and transfer of the input can be easily emulated so as to be approximated to an actual behavior.

The embodiment has been described above. In the above description, typical fillet welding is described as an exemplary welding method. However, the present invention is applicable to any jointing types for welding between sheet metals such as a sheet-to-sheet lap jointing, a T-shaped jointing along the meeting of the sheet metals, and an end-to-end butt jointing. Further, the present invention is applicable to an object in which two sheet metal surfaces meeting each other in any manner are welded to each other, or an object in which two sheet metal surfaces butting to each other in any manner are welded to each other, and those manners may require general fillet welding or any other welding. Further, subjects to be welded are not limited to sheet metals. The present invention is applicable to welding of any members. Moreover, in a case where an object includes three or more members, and each weld joint formed between two of the members is separate from one another, an individual shell element can be applied to each weld joint. For an object in which three or more members are mutually welded at a single weld joint, divisions of the weld joint between every two of the members may be separately defined and modeled by using the respective shell elements. The generalization is apparent from the principle under which arranging a shell element in a weld joint enables representation of moment transfer.

What is claimed is:

1. A CAE (Computer Aided Engineering) analysis method that causes a computer to perform modeling of an object including a plurality of members welded to each other and weld joints formed among the plurality of members, and perform a CAE analysis, wherein
the computer is caused to perform the modeling in which
a model formed by solid elements is applied for each of the plurality of members, based on given data representing a region to be analyzed of the plurality of members,
a model formed by a shell element is applied for each weld joint formed between two members of the plurality of members, based on given data representing a region to be analyzed of the weld joints, and
the shell element applied as the model for each weld joint is arranged inside a dihedral between welded surfaces of the two members, and is coupled to the solid elements applied as the model for each of the two members through internode connection such that the solid elements applied for one of the two members is coupled via rigid elements or beam elements to the shell element and the solid elements applied for the other of the two members is coupled via rigid elements or beam elements to the shell element.

2. The CAE analysis method according to claim 1, wherein the shell element that is applied as the model for each weld joint is arranged on a given surface figure that bridges the welded surfaces of the two members through the dihedral.

3. A CAE (Computer Aided Engineering) analysis apparatus that performs, by a computer, modeling of an object including a plurality of members welded to each other and weld joints formed among the plurality of members, and performs a CAE analysis, wherein
the computer performs the modeling in which
a model formed by solid elements are applied for each of the plurality of members, based on given data representing a region to be analyzed of the plurality of members,
a model formed by a shell element is applied for each weld joint formed between two members of the plurality of members, based on given data representing a region to be analyzed of the weld joints, and
the shell element applied as the model for each weld joint is arranged inside a dihedral between welded surfaces of the two members, and is coupled to the solid elements applied as the model for each of the two members through internode connection such that the solid elements applied for one of the two members is coupled via rigid elements or beam elements to the shell element and the solid elements applied for the other of the two members is coupled via rigid elements or beam elements to the shell element.

4. The CAE analysis apparatus according to claim 3, wherein the shell element that is applied as the model for each weld joint is arranged on a given surface figure that bridges the welded surfaces of the two members through the dihedral.
